(19) United States
(12) Patent Application Publication
(10) Pub. No.: US 2007/0068125 A1
(43) Pub. Date: Mar. 29, 2007

(54) Hoof treatment device having a dual-density pad and method

(76) Inventor: Brian Davis, Ripon, WI (US)

Correspondence Address: RYAN KROMHOLZ & MANION, S.C., POST OFFICE BOX 26618, MILWAUKEE, WI, 53226, US

(21) Appl. No.: 11/236,034

(22) Filed: Sep. 27, 2005

(51) Int. Cl. B68C 5/00

(52) U.S. Cl. 54/82

(57) ABSTRACT

A treatment device for an animal's hoof including a protective boot having a flexible, generally hollow covering adapted to fit over a hoof, and an insert pad member. The insert pad includes a first surface having a first density and a second, oppositely disposed surface having a second density. The insert pad is adapted to be positioned inside the boot and to receive a medicament thereon.

### BACKGROUND OF THE INVENTION

The invention relates generally to treatment devices adapted to supply protection and medicament to the hoofs of hoofed animals. Particularly contemplated is a device which affords the combination of protection along with means to provide for application of a medicament in the case of a diseased or injured hoof.

A variety of devices have been developed for the proper care and treatment of the hoofs of hoofed animals such as horses cows, donkeys and the like. Typically, injured hoofs require protection from contaminants such as mud and manure, with a percentage of these also requiring some form of medicament treatment. Further, since the injured or diseased hoof needing treatment is often tender, treatment devices of this type require gentle, nonirritating surfaces. Additionally, since they are to be attached to an active animal, they need to remain secure during animal activity. Many devices attempting to meet one or several of these requirements have been devised. Some devices have suffered from lack of sufficient fixation means to be held in place in use by an active animal. Other devices suffer from lack of sufficient protection to prevent water, manure and other debris from contacting the injured hoof. Such devices include bandage type devices, hoof guards, and protective boots. While these devices may meet certain objectives, they fail to provide a totality of features in one device. For instance, boot-type devices, which are designed to fit over and be secured to the hoof to be treated, may remain in place over time when worn by an active animal, and further provide protection from contaminants, however the use of medicaments is hampered by a variety of factors. For example, the addition of a liquid or gel medicament into the boot may create a dangerous, slippery surface inside the boot. Additionally, known boots do not allow treatment of a discrete portion of the hoof to be treated, since the medicament is simply poured into the entire boot. This type of application wastes medicament and poses the risk of unwanted effects on the healthy hoof portion.

### SUMMARY OF THE INVENTION

An object of the present invention is to overcome the foregoing shortcomings, and to provide in addition, efficient means for applying a medicament to an injured hoof surface in the treatment of hoof injuries and disorders.

It is a purpose of the present invention to provide a self-contained treatment device which can be applied to an injured hoof, which is of minimal weight and inconvenience to the animal being treated, and which can therefore be left in place on the hoof for prolonged intervals, with selective removal for further treatment and/or viewing of the hoof being treated.

It is another purpose of the present invention to provide a treatment device including an insert pad, the insert pad having a dual density composition wherein a first side, being relatively rigid, provides support and reduces bunching during animal movement, and a second side provides absorptive cushioning for receiving a medicament and providing cushioning for the hoof to be treated.

The treatment device of the present invention is designed to allow continuous soaking when various conditions such as abscesses, thrush, puncture wounds and other aggravated hoof conditions exist. Preferably, the device is made of a relatively soft, pliable material to provide comfort to the hoof during use, while a tough, sole portion provides protection and durability.

The invention provides a protective boot adapted to apply a medicament to an animal's hoof. The boot is preferably of a flexible material of a hollow shape adapted to fit over a hoof. A boot to be used in accordance with the present invention includes an enclosed lower, sole portion for confining and protecting the hoof of an animal. The lower, sole portion preferably includes an outer surface for contacting the ground, and an inner surface adapted for support of the hoof to be treated. The lower, sole portion may be further connected to an upper portion to provide covering and attachment to the animal's leg. The upper portion, as is known, is preferably adapted to be expandable for ease in application to, and removal from, the hoof of an animal. The boot may further include releasable means for securing the device around the leg and hoof of the animal.

The present invention further provides medicament treatment means in the form of an insert pad. The insert pad is preferably made of a dual-density material, having a first, relatively rigid side, and a second, oppositely disposed, relatively absorbent side. The dual-density material is generally flat, of a hoof outline shape, and adapted to fit inside the lower, sole portion of the boot. When placed inside a treatment boot, the first side is preferably located adjacent the inner surface of the lower, sole portion and is adapted for contact with the sole portion. The relatively rigid nature of the first side minimizes undesirable wadding of the pad as the animal moves.

The second, relatively pliable side includes an absorbent surface, and is preferably adapted for contact with the hoof to be treated. The second side is further adapted to receive a medicament thereon, and provides additional cushioning for a tender hoof. An insert pad according to this invention provides both a means to receive and hold medicament adjacent the hoof, and-a means to supply stability to the treatment area. Further, an insert pad according to the present invention also allows for specific placement of medicament relative a portion of the hoof, thereby leaving a portion of the hoof non-treated, if desired. A dual density material in accordance with the present invention may be of a single thickness, or alternatively, may be of at least two-ply construction, depending on desired characteristics.

The present invention allows medications, conditioning oils, and the like to be held adjacent a hoof sole to thereby allow for continuous soaking of the hoof, or a portion thereof. The boot may be removed for inspection or for addition of medication. Medication or oil may be poured onto the insert pad while inside the boot, or the insert pad may be removed from the boot to allow careful placement of medicine thereon. The boot may be further provided with a layered construction to thereby provide a cushioning effect when a tender foot condition exists. In addition, the boot may protect the entire foot from injury during movement or transportation of the animal.

The present device is designed to treat long and short term hoof problems and features a soft boot and insert pad combination that is designed to be gentle on damaged hooves.

### BRIEF DESCRIPTION OF THE DRAWINGS

FIG. 1 is a perspective view of the treatment device of the present invention and showing a hoofed animal leg in phantom.

FIG. 2 is a partially exploded view of an embodiment of the present invention and showing the insert pad outside of the boot.

FIG. 3 is a top plan view of the invention and showing the insert pad in place in the bottom of the boot.

FIG. 4 is a side plan view of the treatment device shown in FIGS. 1-3.

FIG. 4A is a perspective view of an alternative embodiment treatment device.

FIG. 5 is a cross sectional view of the treatment device illustrated in FIG. 3 and taken along lines 5-5 thereof.

FIG. 6 is a cut away, partially exploded view of an embodiment of the treatment device, and showing a medicament on a portion of the insert pad, with an animal's leg and hoof shown in phantom.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

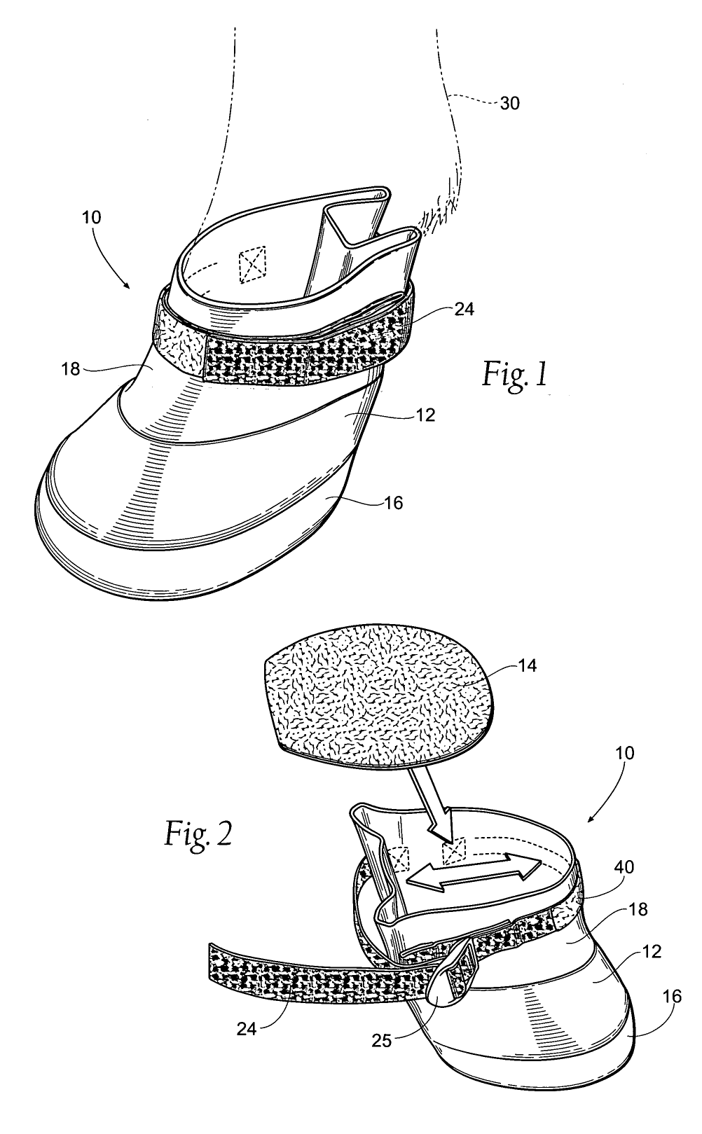

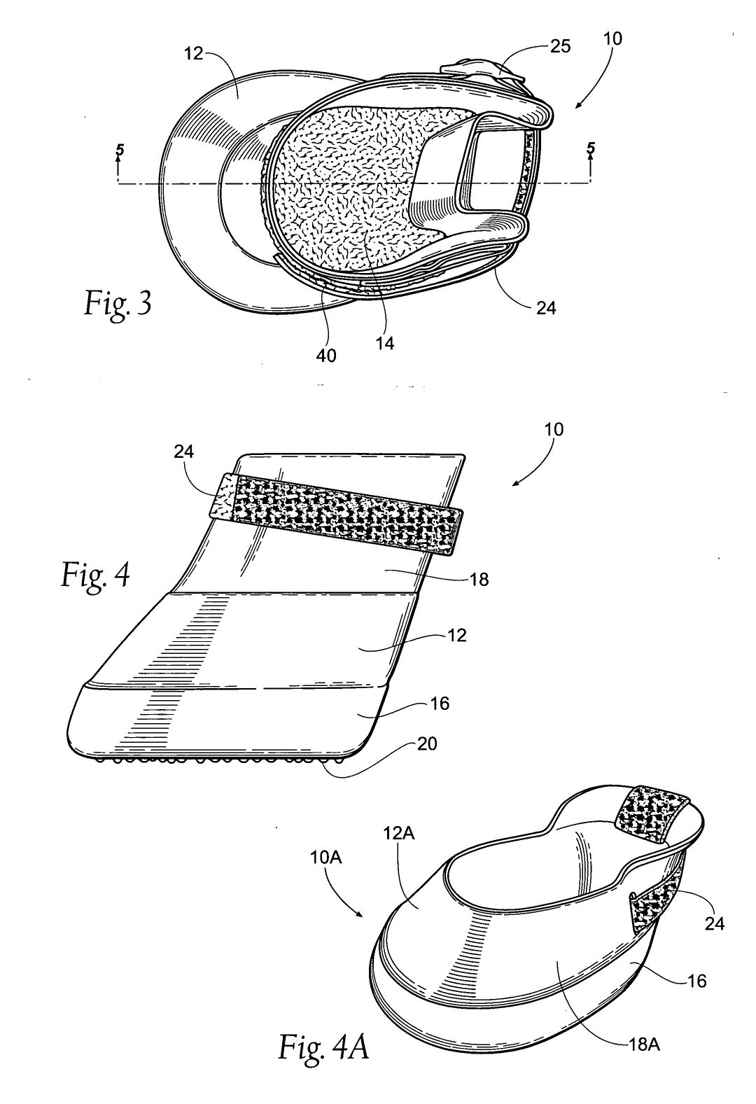

A treatment device for applying a medicament to a hoof, is indicated generally by the reference numeral 10. Referring to FIG. 2, it may be seen that the treatment device 10 includes a boot member 12 and an insert pad member 14. As illustrated, a preferred boot member 12 includes a relatively stiff, lower sole portion 16 and an upper portion 18. As seen particularly in FIG. 1, the lower, sole portion 16 is peripherally connected at its entire top in fluid-tight fashion to upper portion 18, and is shown fit around the leg 30 of a hoofed animal (seen in phantom) . As seen, the upper portion 18 may be of a sufficient length to extend up a portion of the animal's leg 30 past the hoof wall (not shown in this view), or alternatively, as shown in FIG. 4A, may extend up a portion of the hoof wall to leave the leg 30 exposed.

As seen in the Figures, the lower, sole portion 16 is adapted to protect a hoof 32, with the upper portion 18 adapted to protect a portion of the animal's leg 30 above the hoof 32. This feature assists in keeping the hoof 32 to be treated free from unwanted contamination from mud and the like. It is to be understood that the invention may be practiced with the relatively shorter upper portion 18A illustrated in FIG. 4A.

The lower, sole portion 16 preferably includes an outer surface 20 for contacting the ground, and an inner surface 22 adapted for support of the hoof 32 to be treated. The outer surface 20 may be textured, as shown in FIGS. 4 and 6, to thereby provide traction, if desired. As noted previously, the lower, sole portion 16 may be further connected to an upper portion 18. The upper portion 18, as is known, is preferably adapted to be expandable for ease in application to, and removal from, the hoof of an animal. The device 10 may further include releasable means for securing the device 10 around the leg and hoof 32 of the animal. The device 10 may be secured by way of any acceptable holding means, including the adjustable straps 24 shown. The holding and attachment elements are preferably adjustable to various positions in order to accommodate, hoofs and legs of various sizes. The holding elements may be constructed of any functional material, but are preferably constructed from straps 24 as shown, and provided with attachment means. The attachment means may be any conventional means, such as the buckles 25 shown in the Figures. Alternatively the straps may be provided with conventional hook and loop fasteners. Also contemplated is the use of a combination of attachment means, such as the buckles 25 with hook and loop fasteners 40 for added secure attachment, shown.

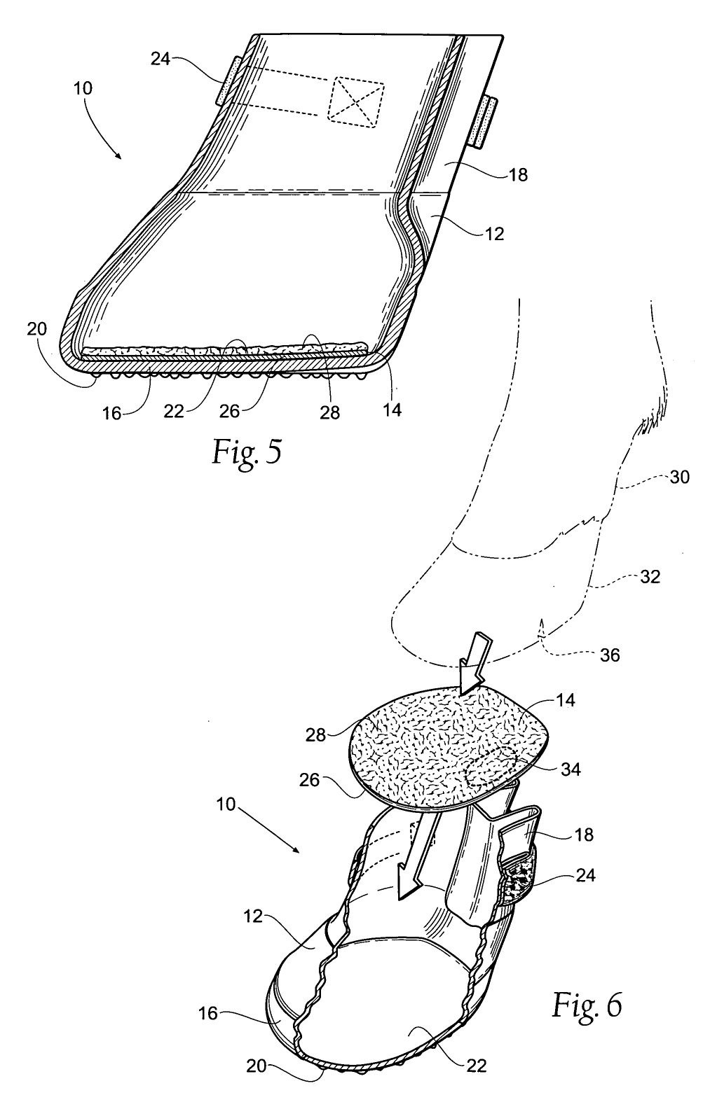

The present device 10 further provides medicament treatment means in the form of an insert pad member 14. As may be seen particularly in FIGS. 2, 5, and 6, the insert pad member 14 is preferably made of a dual-density material, having a first, relatively rigid side 26, and a second, oppositely disposed, relatively absorbent side 28. The dual-density insert pad member 14 is generally flat, of a hoof outline shape, and adapted to fit inside the lower, sole portion 16 of a boot member 12. When placed inside a treatment boot 12, the first side 26 is preferably located adjacent the inner surface 22 of the lower, sole portion 16 and is adapted for contact with the sole portion 16. The relatively rigid nature of the first side 26 minimizes undesirable wadding of the insert pad member 14 as the animal moves.

The second, relatively absorbent side 28 includes an absorbent surface, and is preferably adapted for contact with the hoof 32 to be treated. The second side 28 is further adapted to receive a medicament 34 thereon, and provides additional cushioning for a tender hoof 32. An insert pad member 14 according to this invention provides both a means to receive and hold medicament 34 adjacent the hoof 32, and a means to supply stability to the treatment area. Further, and as illustrated particularly in FIG. 6, an insert pad member 14 according to the present invention also allows for specific placement of medicament 34 relative an injured portion 36 of the hoof 32, thereby leaving a portion of the hoof 32 non-treated, if desired. A dual density material in accordance with the present invention may be of various construction, including but not limited to a non-woven, solution dyed polyester and polypropylene pad, and may be of a single thickness, or alternatively, may be of multi-ply construction, depending on desired characteristics.

A method of treating a hoof using the treatment device 10 includes the steps of: (a) providing an insert pad member 14, insert pad member 14 having a first, relatively rigid side 26 and a second, oppositely disposed, absorbent side 28; (b) applying a predetermined medicament 34 to the second side 28; (c) providing a boot member 12 having a sole portion 16, the sole portion 16 having an inner surface 22 and an outer surface 20; (d) positioning the insert pad member 14 into the boot member 12 such that the first side 26 is in overlaying contact with the inner surface 22; and (e) placing the boot 12 over a hoof 32 such that the second side the said hoof 32.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I Claim:

1. An apparatus for the treatment of a hoof comprising:
a boot having a relatively stiff sole portion and an upper portion, said upper portion being peripherally connected to said sole portion and adapted for removable conforming application to said hoof;
said sole portion having an interior surface and an exterior surface;
an insert pad member, said insert pad member having a first surface and a second, oppositely disposed surface, the insert pad member adapted to be positioned inside said boot such that said first surface overlays said interior surface of said sole portion;
said first surface having a first predetermined density; and
said second surface having a second predetermined density.

2. The apparatus of claim 1 wherein said second surface of said insert pad member is adapted to receive a medicament thereon.

3. An apparatus for applying a medicament to a hoof, comprising:
a boot having a generally hollow shape to fit an animal's hoof, said boot including a sole portion having a top edge, and an upper portion, said sole portion being connected at said top edge to said upper portion; said sole portion including an inner surface;
an insert pad member, said insert pad member having a first side and a second, oppositely disposed side, said first side overlaying at least a portion of said inner surface, said second side adapted to receive a medicament thereon; and
means for securing said apparatus to said hoof.

4. An apparatus according to claim 3 wherein said boot is a single molded product of plastic material.

5. An apparatus according to claim 3 wherein said means for securing comprises at least a pair of mating fasteners.

6. An apparatus according to claim 5 wherein said at least a pair of mating fasteners is comprised of hook and loop type fabric.

7. An apparatus according to claim 5 wherein said at least a pair of mating fasteners is comprised of a buckle.

8. A method of applying a medicament to a hoof comprising the steps of:
providing an insert pad member, said insert pad member having a first, relatively rigid side and a second, oppositely disposed, absorbent side;
applying a predetermined medicament to said second side;
providing a boot having a sole portion, said sole portion having an inner surface and an outer surface;
positioning said insert pad member into said boot such that said first side is in overlaying contact with said inner surface; and
placing said boot over a hoof such that said second side and predetermined medicament is maintained in contact with said hoof.

9. A pad for treating a hoof comprising:
a first surface and a second, oppositely disposed surface, the pad being adapted to be positioned inside a treatment boot such that said first surface overlays an interior surface of said treatment boot;
said first surface having a first predetermined density;
said second surface having a second predetermined density.

10. The pad according to claim 9 wherein said second surface is adapted to receive a medicament thereon.
